(19) United States
(12) Patent Application Publication
(10) Pub. No.: US 2024/0176222 A1
(43) Pub. Date: May 30, 2024

(54) TRANSPARENT STRUCTURE AND SCREEN FOR BEAM PROJECTOR INCLUDING SAME

(71) Applicant: Electronics and Telecommunications Research Institute, Daejeon (KR)

(72) Inventors: Gi Heon KIM, Daejeon (KR); Won Jae LEE, Daejeon (KR)

(73) Assignee: Electronics and Telecommunications Research Institute, Daejeon (KR)

(21) Appl. No.: 18/453,859

(22) Filed: Aug. 22, 2023

(30) Foreign Application Priority Data
Nov. 15, 2022 (KR) 10-2022-0152207

(51) Int. Cl. G03B 21/62; C09K 19/54; C09K 19/60; G02F 1/1334

(52) U.S. Cl. CPC G03B 21/62; C09K 19/544; C09K 19/601; C09K 19/603; G02F 1/1334; C09K 2019/525

(57) ABSTRACT

A transparent structure according to an embodiment of the present disclosure includes a first panel and a second panel, wherein the first panel includes: a first electrode; a second electrode separated from the first electrode; and a polymer dispersed liquid crystal layer disposed between the first electrode and the second electrode, the second panel includes: a third electrode; a fourth electrode separated from the third electrode; and a colloid layer disposed between the third electrode and the fourth electrode, the fourth electrode includes multiple openings, and the colloid layer includes charged particles of which surfaces exhibit (+) charge or (−) charge.

### CROSS-REFERENCE TO RELATED APPLICATIONS

This U.S. non-provisional patent application claims priority under 35 U.S.C. § 119 of Korean Patent Application No. 10-2022-0152207, filed on Nov. 15, 2022, the entire contents of which are hereby incorporated by reference.

### BACKGROUND

The present disclosure herein relates to a transparent structure, and more particularly to a transparent structure including a polymer-liquid crystal dispersion layer and a colloid layer, and a screen for a beam projector including same.

Beam projectors and screens for beam projectors are devices capable of projecting images or photographs, and are classified into an LCD, a DLP and a laser projector according to a projection method, or classified into an LED, a laser, a general lamp, a hybrid projector, or the like according to a light source. Beam projectors may project images by a method of projecting light on a screen and have advantages in projecting images to a desired direction in a desired size by controlling the distance between the beam projector and the screen and the arrangement thereof in contrast to the conventional TV, and advantages in that they are light and easy to move around.

Recently, beam projectors are widely used for sharing video conference in an office, or as the replacements of expensive large screen televisions outdoors or at home. The movement or location change of the beam projector depending on the environment or object of use, are relatively easy, but the movement or the direction change of the screen is limited, and generally, the screen is fixed on one side of a wall and used. In order to solve this task, a screen stand has been utilized as a screen mobility aid, but in this case, there are defects in that space utilization is deteriorated, and mobile installation is cumbersome. In addition, even a roll-type screen of which top is fixed, has defects in that a temporary expansion process for use is cumbersome.

### SUMMARY

A task for solving of the present disclosure is to provide a screen for a beam projector, including a transparent structure with improved convenience.

Another task for solving of the present disclosure is to provide a screen for a beam projector, including a transparent structure which is capable of switching quickly between a transmission type and a reflection type screen.

The tasks for solving of the present disclosure are not limited to the aforementioned tasks, and unreferred other tasks may be clearly understood by a person skilled in the art from the description below.

A transparent structure according to an embodiment of the inventive concept includes a first panel and a second panel, wherein the first panel includes: a first electrode; a second electrode separated from the first electrode; and a polymer dispersed liquid crystal layer disposed between the first electrode and the second electrode, the second panel includes: a third electrode; a fourth electrode separated from the third electrode; and a colloid layer disposed between the third electrode and the fourth electrode, the fourth electrode includes multiple openings, and the colloid layer includes charged particles of which surfaces exhibit (+) charge or (−) charge.

In an embodiment, the polymer dispersed liquid crystal layer may include a ultraviolet curable polymer and first liquid crystals, and the first liquid crystals may have a weight ratio of about 80 wt % to about 120 wt % based on the ultraviolet curable polymer.

In an embodiment, the ultraviolet curable polymer may be cured using ultraviolet with a wavelength of about 250 nm to about 400 nm, and energy with about 50 mJ to about 2000 mJ.

In an embodiment, a flow viscosity of the first liquid crystals may be from about 15 mm²/s to about 100 mm²/s, a refractive index anisotropy of the first liquid crystals may be from about 0.10 to about 0.30, and a dielectric anisotropy of the first liquid crystals may be from about +2.0 to about +50.0.

In an embodiment, the polymer dispersed liquid crystal layer may further include a black dye, the black dye may include at least one among a first black dye, a second black dye, and a third black dye, the first black dye may be a compound in which three naphthalene rings are connected via two azo groups, the second black dye may be a compound in which two naphthalene rings and one aromatic ring are connected via two azo groups, and the third black dye may be a compound in which three naphthalene rings and one aromatic ring are connected via three azo groups.

In an embodiment, the first black dye may be represented by Formula 1, Formula 2 or Formula 3.

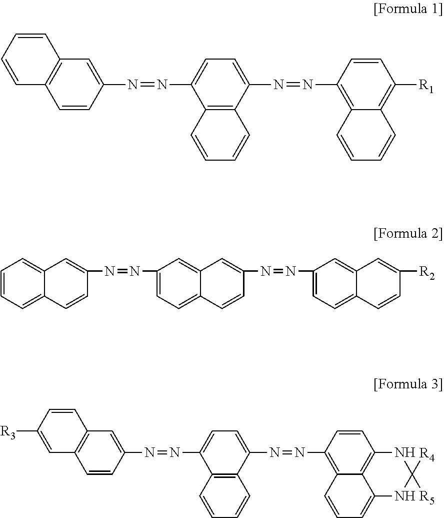

In Formula 1, Formula 2 and Formula 3, R₁, R₂, R₃, R₄, and R₅ may be each independently —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

In an embodiment, the second black dye may be represented by Formula 4, Formula 5 or Formula 6.

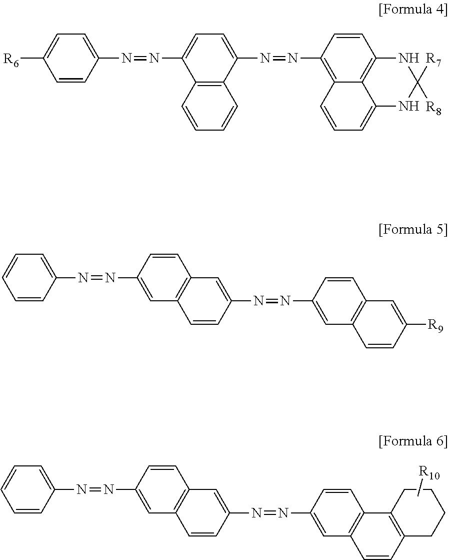

In Formula 4, Formula 5 and Formula 6, R₆, R₇, R₈, R₉, and R₁₀ may be each independently —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

In an embodiment, the third black dye may be represented by Formula 7 or Formula 8.

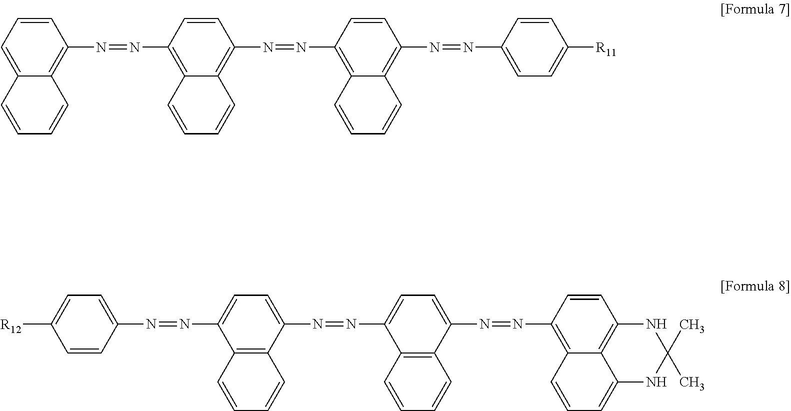

In Formula 7 and Formula 8, R₁₁ and R₁₂ may be each independently —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

In an embodiment, the colloid layer may further include a hydrophobic organic solvent, and the hydrophobic organic solvent may include at least one among halocarbon oil and Rhodiasolv IRIS oil.

In an embodiment, the colloid layer may further include second liquid crystals, a flow viscosity of the second liquid crystals may be from about 20 mm²/s to about 100 mm²/s, a refractive index anisotropy of the second liquid crystals may be from about 0.05 to about 0.30, and a dielectric anisotropy of the second liquid crystals may be from about +5.0 to about +40.0.

In an embodiment, the colloid layer may further include at least one among a yellow dye, a magenta dye, and a cyan dye, and the yellow dye, the magenta dye, and the cyan dye may have a weight ratio of about 0.02 wt % to about 10 wt % based on the second liquid crystals.

In an embodiment, the yellow dye may be represented by Formula 9.

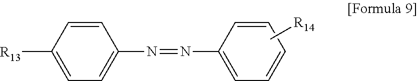

In Formula 9, R₁₃ is —N(CH₃)₂, —N(C₂H₅)₂ or —N(X)₂, where X is an alkyl chain of 3 to 10 carbon atoms. In Formula 9, R₁₄ may be —H, —CH₃, —C₂H₅, a linear alkyl group of 3 to 10 carbon atoms, a branched alkyl group of 3 to 10 carbon atoms, a linear alkene group of 3 to 10 carbon atoms, a branched alkene group of 3 to 10 carbon atoms, or one or more aromatic groups.

In an embodiment, the magenta dye may be represented by Formula 10.

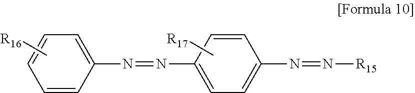

In Formula 10, R₁₆ and R₁₇ may be each independently, —H, —CH₃, —C₂H₅, a linear alkyl group of 3 to 10 carbon atoms, a branched alkyl group of 3 to 10 carbon atoms, a linear alkene group of 3 to 10 carbon atoms, a branched alkene group of 3 to 10 carbon atoms, or one or more aromatic groups.

In Formula 10, R₁₅ may be represented by Formula 10-1, Formula 10-2, Formula 10-3, or Formula 10-4.

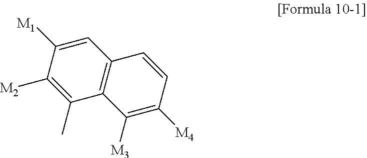

In Formula 10-1, any one among M₁, M₂, M₃, and M₄ may be —OH, and the remainder may be —H.

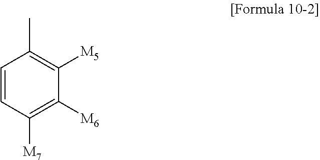

In Formula 10-2, any one among M₅, M₆, and M₇ may be —OH, and the remainder may be —H.

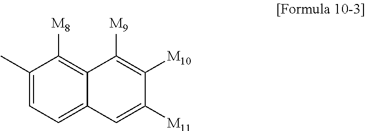

In Formula 10-3, any one among M₈, M₉, M₁₀, and M₁₁ may be —OH, and the remainder may be —H.

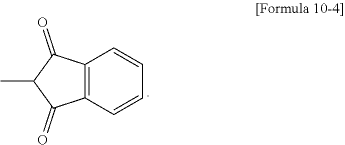

In an embodiment, the cyan dye may be represented by Formula 11.

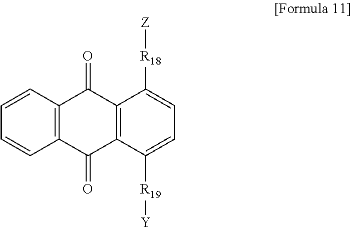

In Formula 11, R₁₈ and R₁₉ are each independently, O, S, Se, CH₂, NH or ester. In Formula 11, Y and Z may be each independently —H, —CH₃, —C₂H₅, a linear alkyl group of 3 to 10 carbon atoms, a branched alkyl group of 3 to 10 carbon atoms, a linear alkene group of 3 to 10 carbon atoms, a branched alkene group of 3 to 10 carbon atoms, or one or more aromatic groups.

In an embodiment, the first panel may include a first control part connected with the first electrode and the second electrode, and the second panel may include a second control part connected with the third electrode and the fourth electrode.

A transparent structure according to an embodiment of the inventive concept includes: a first panel; and a second panel on the first panel, wherein the first panel includes: a first transparent substrate; a first transparent electrode on the first transparent substrate; a second transparent electrode separated from the first transparent electrode; a second transparent substrate on the second transparent electrode; a polymer dispersed liquid crystal layer disposed between the first transparent electrode and the second transparent electrode; and a first control part connected with the first transparent electrode and the second transparent electrode, the second panel includes: a third transparent substrate; a third transparent electrode on the third transparent substrate; a fourth transparent electrode separated from the third transparent electrode and including multiple openings; a fourth transparent substrate on the fourth transparent electrode; a colloid layer disposed between the third transparent electrode and the fourth transparent electrode; and a second control part connected with the third transparent electrode and the fourth transparent electrode, the polymer dispersed liquid crystal layer includes a ultraviolet curable polymer and first liquid crystals, and the colloid layer includes charged particles of which surfaces exhibit (+) charge or (−) charge.

In an embodiment, when a voltage is applied through the first control part to the first transparent electrode and the second transparent electrode, the first liquid crystals may be aligned in parallel to each other.

In an embodiment, when a voltage is applied through the second control part to the third transparent electrode and the fourth transparent electrode, the charged particles may move to the third transparent electrode or the fourth transparent electrode.

### BRIEF DESCRIPTION OF THE FIGURES

The accompanying drawings are included to provide a further understanding of the inventive concept and are incorporated in and constitute a part of this specification. The drawings illustrate embodiments of the inventive concept and, together with the description, serve to explain principles of the inventive concept. In the drawings:

FIG. 1 is a cross-sectional view of a transparent structure according to an embodiment of the inventive concept;

FIG. 2 is an enlarged view for explaining a transparent structure according to an embodiment of the inventive concept and is an enlarged view on area A of FIG. 1;

FIG. 3 is an enlarged view for explaining a transparent structure according to an embodiment of the inventive concept and is an enlarged view on area B of FIG. 1;

FIG. 4 is a concept diagram for explaining a portion of a transparent structure in a state of not applying a driving voltage, and corresponds to an enlarged view on area C of FIG. 2;

FIG. 5 is a concept diagram for explaining a portion of a transparent structure in a state of applying a driving voltage, and corresponds to an enlarged view on area C of FIG. 2;

FIG. 6 is a concept diagram for explaining a portion of a transparent structure in a state of applying a driving voltage, and corresponds to an enlarged view on area B of FIG. 1;

FIG. 7 is a concept diagram for explaining a portion of a transparent structure in a state of applying a driving voltage, and corresponds to an enlarged view on area B of FIG. 1; and

FIGS. 8 and 9 are concept diagrams showing screens for a beam projector including a transparent structure according to an embodiment of the inventive concept.

### DETAILED DESCRIPTION

Preferred embodiments of the inventive concept will be explained with reference to the accompany drawings for sufficient understanding of the configurations and effects of the inventive concept. The inventive concept may, however, be embodied in various forms, have various modifications and should not be construed as limited to the embodiments set forth herein. The embodiments are provided to complete the disclosure of the inventive concept through the explanation of the embodiments and to completely inform a person having ordinary knowledge in this technical field to which the inventive concept belongs of the scope of the inventive concept. A person having ordinary knowledge in this technical field might understand suitable environments in which the inventive concept may be performed.

In the disclosure, the terms used herein are to explain the embodiments but are not to limit the inventive concept. In the disclosure, the singular forms are intended to include the plural forms as well, unless the context clearly indicates otherwise. The terms “comprises” and/or “comprising,” used in the disclosure, specify the presence of stated materials, elements, steps and/or devices, but do not preclude the presence or addition of one or more other materials, elements, steps and/or devices.

In the disclosure, it will be understood that when a film (or layer) is referred to as being on another film (or layer), it can be directly formed on the other film (or layer) or a substrate, or a third intervening film (or layer) may be present.

In various example embodiments in the disclosure, although the terms first, second, third, etc. may be used herein to describe various regions, films (or layers), etc., these regions and films should not be limited by these terms. These terms are only used to distinguish one region or film (or layer) from another region or film (or layer). Thus, a first layer material referred to in an embodiment could be termed a second layer material in another embodiment. Embodiments explained and illustrated herein may include their complementary embodiments. In the description, parts designated by the same reference numerals refer to the same configuration elements throughout.

The terms used in the embodiments of the inventive concept may be interpreted as commonly known meanings to a person having common knowledge in this technical field, unless otherwise defined.

Hereinafter, embodiments of the inventive concept will be explained referring to the drawings.

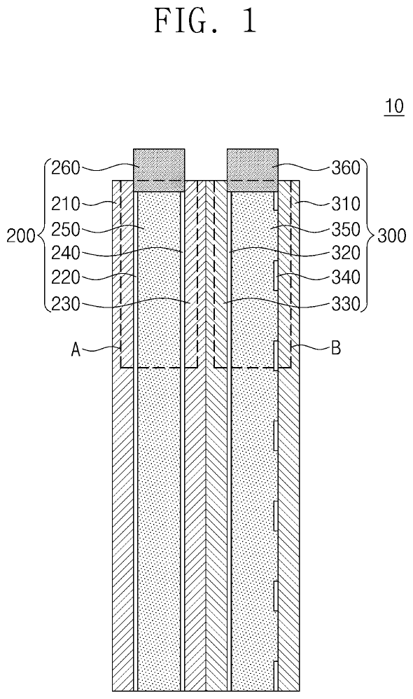

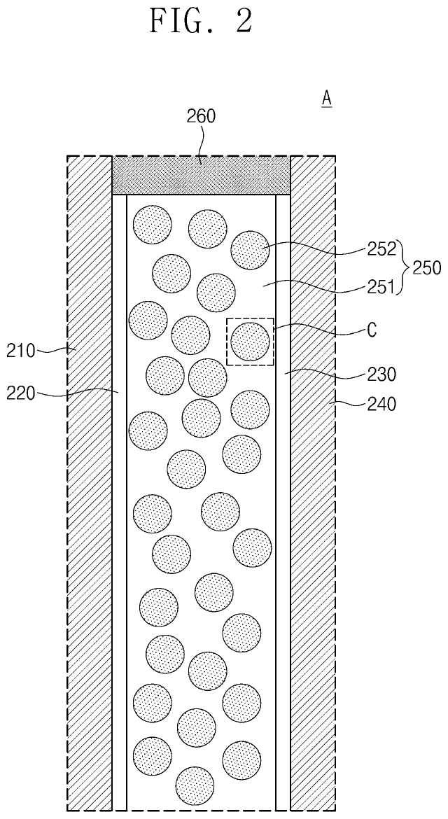

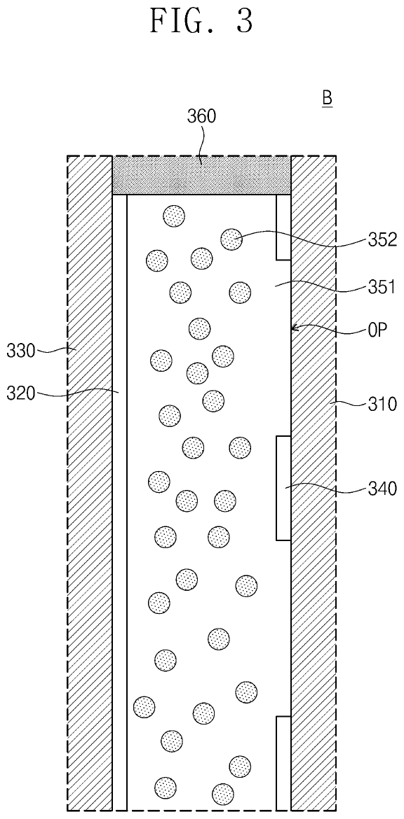

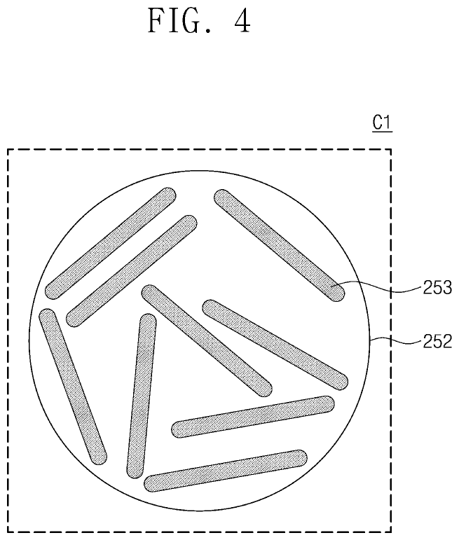

FIG. 1 is a cross-sectional view of a transparent structure according to an embodiment of the inventive concept. FIG. 2 is an enlarged view for explaining a transparent structure according to an embodiment of the inventive concept and is an enlarged view on area A of FIG. 1. FIG. 3 is an enlarged view for explaining a transparent structure according to an embodiment of the inventive concept and is an enlarged view on area B of FIG. 1. FIG. 4 is a concept diagram for explaining a portion of a transparent structure in a state of not applying a driving voltage, and corresponds to an enlarged view on area C of FIG. 2.

Referring to FIG. 1 to FIG. 4, a transparent structure 10 may include a first panel 200 and a second panel 300. The first panel 200 may include a first substrate 210, a first electrode 220, a second substrate 230, a second electrode 240, a polymer dispersed liquid crystal layer 250 and a first control part 260. The second panel 300 may include a third substrate 310, a third electrode 320, a fourth substrate 330, a fourth electrode 340 and a colloid layer 350.

On the first substrate 210, the first electrode 220 may be provided. The first substrate 210 may be transparent. The first substrate 210 may include glass or plastic. The first electrode 220 may be transparent. The first electrode 220 may include a conductive material. In an embodiment, the first electrode 220 may include at least one among indium tin oxide (ITO), indium zinc oxide (IZO), silver nanowire, carbon nanotube (CNT), graphene, PEDOT:PSS, polyaniline, and polythiophene. Preferably, the first electrode 220 may be ITO. The first electrode 220 may be formed without performing a separate patterning process.

The second electrode 240 may be provided to separately face the first electrode 220. On the second electrode 240, the second substrate 230 may be provided. The second electrode 240 may be provided on one surface of the second substrate 230 facing the first substrate 210. The first electrode 220 may be provided on one surface of the first substrate 210 facing the second substrate 230. The second substrate 230 may be transparent. The second substrate 230 may include substantially the same material as the first substrate 210. The second electrode 240 may be transparent. The second electrode 240 may include substantially the same material as the first electrode 220. The second electrode 240 may be formed without performing a separate patterning process.

A polymer dispersed liquid crystal layer 250 may be disposed between the first electrode 220 and the second electrode 240. The polymer dispersed liquid crystal layer 250 may include a ultraviolet curable polymer 251 and multiple liquid crystal droplets 252. The polymer dispersed liquid crystal layer 251 may be from about 2.5 um to about 100 um. The liquid crystal droplets 252 may be dispersed in the ultraviolet curable polymer 251. The ultraviolet curable polymer 251 may be a polymer material cured by ultraviolet light. The ultraviolet curable polymer 251 may be a polymer material cured by ultraviolet light with a wavelength of about 250 nm to about 400 nm, and energy with about 50 mJ to about 2000 mJ.

The ultraviolet curable polymer 251 may include any one among an amorphous type, a semicrystalline monomer, or an oligomer. Preferably, the ultraviolet curable polymer may include at least one among an urethane acrylate oligomer (molecular weight, 1000-4000), 2(2-ethoxyethoxy) ethyl acrylate (EOEOEA), isobornyl acrylate (IOBA), triethylopropane triacrylate (TMPTA), tri(propylene glycol) diacrylate (TPGDA), penthaerythritol triacrylate (PETA), hydroxyethyl acrylate (HEA), trimethylolpropane ethoxylate triacrylate (TMPEOTA), 2-phenoxyethyl acrylate (2-PEA), methyl methacrylate (MMA), methacrylate (MA), tetrahydrofurfuryl acrylate, tri(propylene glycol) glycerolate diacrylate (TPGDA), vinyl acrylate (VA), ethylene glycol dimethacrylate (EGDA), an epoxy acrylate monomer or oligomer, 1,6-hexandiol diacrylate (HAD), 2-hydroxyethyl methacrylate (2-HEMA), 2-ethylheyxyl acrylate, ethylene glycol diacrylate, trimethylolpropane dially ether, urethane diacrylate, 2-phenoxyethyl acrylate, and tetrahydrofurfuryl acrylate.

Each liquid crystal droplet 252 may have a sphere shape and may include multiple first liquid crystals 253. Each of the first liquid crystals 253 may have a thin and long rod shape. If an electric field is applied, each of the liquid crystals 253 may be aligned in a parallel direction to the direction of the electric field. The first liquid crystals 253 may be nematic liquid crystals having negative dielectric permittivity. The flow viscosity of the first liquid crystals 253 may be from about 15 mm²/s to about 100 mm²/s. The refractive index anisotropy of the first liquid crystals 253 may be from about 0.10 to about 0.30, and the dielectric anisotropy (1.0 kHz) may be from about (+) 2.0 to about (+) 50.0. The first liquid crystals 253 may have a weight ratio of about 80 wt % to about 120 wt % based on the ultraviolet curable polymer 251.

The polymer dispersed liquid crystal layer 250 may further include at least one among a dispersant (not shown), and a ultraviolet photoinitiator (not shown). During curing the ultraviolet curing polymer 251, a curing ratio may be improved by the ultraviolet photoinitiator. The ultraviolet photoinitiator may have a weight ratio of about 0.5 wt % to about 10 wt % based on the ultraviolet curing polymer 251.

The ultraviolet photoinitiator may include, for example, at least one among 1-hydroxy-cyclohexyl-phenyl-ketone (Irgacure 907), 2-methyl-1[4-(methylthio)phenyl]-2-morpholinopropane-1-one (Irgacure 184C), 1-hydroxy-2-methyl-1-phenyl-propane-1-one (Darocur 1173), a mixture initiator of about 50 wt % of Irgacure 184C and about 50 wt % of benzophenone (Irgacure 500), a mixture initiator of about 20 wt % of Irgacure 184 and about 80 wt % of Irgacure 1173 (Irgacure 1000), 2-hydroxy-1-[4-(2-hydroxyethoxy)phenyl]-2-methyl-1-propanone (Irgacure 2959), methyl benzoylformate (Darocur MBF), alpha, alpha-dimethoxy-alpha-phenylacetophenone (Irgacure 651), 2-benzyl-2-(dimethylamino)-1-[4-(morpholinyl)phenyl]-1-butanone (Irgacure 369), a mixture initiator of about 30 wt % of Irgacure 369 and about 70 wt % of Irgacure 651 (Irgacure 1300), diphenyl (2,4,6-trimethylbenzoyl)-phosphine oxide (Darocur TPO), a mixture initiator of about 50 wt % of Darocur TPO and about 50 wt % of Darocur 1173 (Darocur 4265), [phosphine oxide, phenyl bis(2,4,6-trimethyl benzoyl)] (Irgacure 819), 2-hydroxy-2-methyl-1-phenyl-propane-1-one (Darocur 1173), a mixture initiator of about 5 wt % of Irgacure 819 and about 95 wt % of Darocur 1173 (Irgacure 2005), a mixture initiator of about 10 wt % of Irgacure 819 and about 90 wt % of Darocur 1173 (Irgacure 2010), a mixture initiator of about 20 wt % of Irgacure 819 and about 80 wt % of Darocur 1173 (Irgacure 2020), bis(.eta.5-2,4-cyclopentadien-1-yl) bis[2,6-difluoro-3-(1H-pyrrol-1-yl)phenyl]titanium (Irgacure 784), a mixture initiator containing benzophenone (HSP 188), 1-hydroxy-cyclohexylphenyl-ketone (CPA), and 2,4,6,-trimethylbenzoyl-diphenyl-phosphineoxide (Darocur TPO).

The polymer dispersed liquid crystal layer 250 may be formed by, for example, a coating method. For example, the polymer dispersed liquid crystal layer 250 may be formed by at least one among spin coating, bar coating, and screen printing methods. In another embodiment, the polymer dispersed liquid crystal layer 250 may be formed by a capillary injection, or a dropping method.

The polymer dispersed liquid crystal layer 250 may further include a black dye. The black dye may include at least one among a first black dye, a second black dye, and a third black dye.

The first black dye may include a compound in which three naphthalene rings are connected via two azo groups. In an embodiment, the first black dye may include a compound represented by [Formula 1].

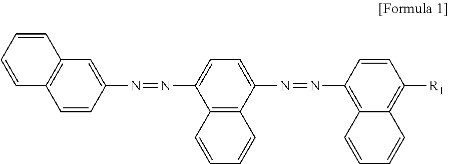

In [Formula 1], R₁ may be —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

In another embodiment, the first black dye may include a compound represented by [Formula 2].

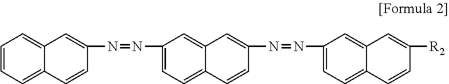

In [Formula 2], R₂ may be —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

In another embodiment, the first black dye may include a compound represented by [Formula 3].

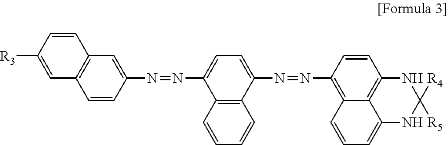

In [Formula 3], R₃, R₄, and R₅ may be each independently —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

The second black dye may include a compound in which two naphthalene rings and one aromatic group are connected via two azo groups. In an embodiment, the second black dye may include a compound represented by [Formula 4].

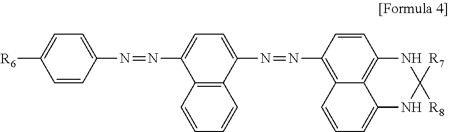

In [Formula 4], R₆, R₇, and R₈ may be each independently —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

In another embodiment, the second black dye may include a compound represented by [Formula 5].

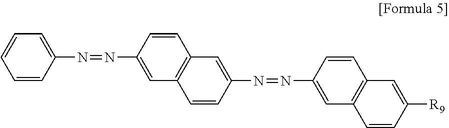

In [Formula 5], R₉ may be —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

In another embodiment, the second black dye may include a compound represented by [Formula 6].

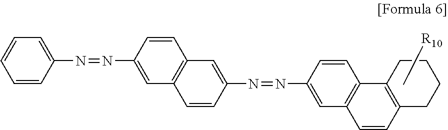

In [Formula 6], R₁₀ may be —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

The third black dye may include a compound in which three naphthalene rings and one aromatic group are connected via three azo groups. In an embodiment, the third black dye may include a compound represented by [Formula 7].

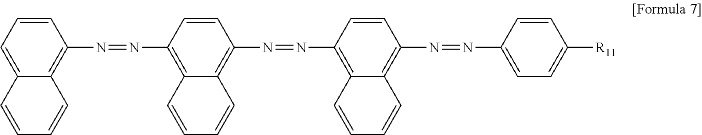

In [Formula 7], R₁₁ may be —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

In another embodiment, the third black dye may include a compound represented by [Formula 8].

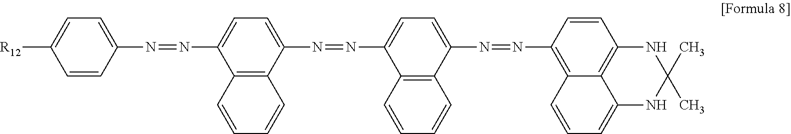

In [Formula 8], R₁₂ may be —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

A first control part 260 may be provided on the first electrode 220, the second electrode 240 and the polymer dispersed liquid crystal layer 250. The first control part 260 may be connected with the first electrode 220 and the second electrode 240 and may apply a driving voltage. Accordingly, the first control part 260 may control the light transmittance of the polymer dispersed liquid crystal layer 250.

On the third substrate 310, a third electrode 320 may be provided. The third substrate 310 may be transparent. The third substrate 310 may include glass or plastic. The third electrode 320 may be transparent. The third electrode 320 may include a conductive material. In an embodiment, the third electrode may include the same material as the first electrode 220. Preferably, the third electrode 320 may be indium tin oxide (ITO). The third electrode 320 may be formed without performing a separate pattering process.

A fourth electrode 340 may be provided to separately face the third electrode 320. On the fourth electrode 340, the fourth substrate 330 may be provided. The fourth electrode 340 may be provided on one surface of the fourth substrate 330, facing the third substrate 330. The third electrode 320 may be provided on one surface of the third substrate 310, facing the fourth substrate 330. The fourth substrate 330 may be transparent. The fourth substrate 330 may include substantially the same material as the third substrate 310. The fourth electrode 340 may be transparent. The fourth electrode 340 may include substantially the same material as the third electrode 320. The fourth electrode 340 may include multiple openings OP.

A colloid layer 350 may be disposed between the third electrode 320 and the fourth electrode 320. The colloid layer 350 may include a solvent 351 and charged particles 352. The charged particles 352 may be dispersed in the solvent 351.

The solvent 351 may be a hydrophobic organic solvent or second liquid crystals. The hydrophobic organic solvent may include at least one among halocarbon oil (a polymer of chlorotrifuloroethylene (PCTFE) with a low molecular weight) and Rhodiasolv IRIS oil. The second liquid crystals may have a thin and long rod shape. If an electric field is applied, the second liquid crystals may be aligned in a direction parallel to the direction of the electric filed. The second liquid crystals may include a tail region composed of an alkyl chain for providing flowability, a mesogenic group composed of an aromatic group, and a polar terminal group determining dielectric anisotropy. The polar terminal group may include at lest one among —F, —OCF₃, OCF₂H, —CF₃, —CF₂H, —CFH₂, —OCF₂CF₂H, —CN, —Cl, —SH, —OCH₃, and —OH. The flow viscosity of the second liquid crystals may be from about 20 mm²/s to about 100 mm²/s. The refractive index anisotropy of the second liquid crystals may be from about 0.05 to about 0.30, and the dielectric anisotropy of the second liquid crystals may be from about (+)2.0 to about (+)40.0. The cleaning temperature of the second liquid crystals may be from about 60° C. to about 110° C.

The charged particles 352 may be charged so that the surfaces thereof may exhibit (+) charge or (−) charge. Preferably, the charged particles 352 may be charged to exhibit (−) charge. The charged particles 352 may be white particles. In another embodiment, the charged particles 352 may be particles which are transparent or have other color. In an embodiment, the charged particles 352 may include TiO₂.

The charged particles 352 of which surfaces are charged with (−) may be dispersed in the second liquid crystals having (+) dielectric anisotropy. In this case, if a driving voltage is applied, the second liquid crystals may be re-aligned in the direction of an electric field, while reducing a viscosity in the direction of the electric field, and increasing the mobility of the charged particles 352.

The colloid layer 350 may further include a dye which has selective solubility in the second liquid crystals. The dye may improve visibility. The dye may include an aromatic ring, or a fused ring. The aromatic ring or fused ring of the dye may improve the interaction with the second liquid crystals and may increase solubility.

The dye may include at least one among a yellow dye, a magenta dye, and a cyan dye. The dye may have a weight ratio of about 0.01 wt % to about 20 wt % based on the second liquid crystals. Preferably, the dye may have a weight ratio of about 0.02 wt % to about 10 wt %.

The yellow dye may include a compound in which two aromatic rings are connected via an azo group. In an embodiment, the yellow dye may include a compound represented by [Formula 9] below.

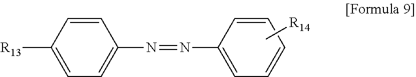

In [Formula 9], R₁₃ may be —N(CH₃)₂, —N(C₂H₅)₂ or —N(X)₂. X may be an alkyl chain of 3 to 10 carbon atoms. In [Formula 9], R₁₄ may be —H, —CH₃, —C₂H₅, a linear alkyl group of 3 to 10 carbon atoms, a branched alkyl group of 3 to 10 carbon atoms, a linear alkene group of 3 to 10 carbon atoms, a branched alkene group of 3 to 10 carbon atoms, or one or more aromatic groups.

In an embodiment, the magenta dye may include a compound represented by [Formula 10] below.

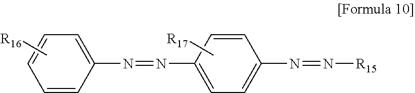

In [Formula 10], R₁₆ and R₁₇ may be each independently, —H, —CH₃, —C₂H₅, a linear alkyl group of 3 to 10 carbon atoms, a branched alkyl group of 3 to 10 carbon atoms, a linear alkene group of 3 to 10 carbon atoms, a branched alkene group of 3 to 10 carbon atoms, or one or more aromatic groups.

In [Formula 10], R₁₅ may be represented by any one among [Formula 10-1], [Formula 10-2], [Formula 10-3], and [Formula 10-4].

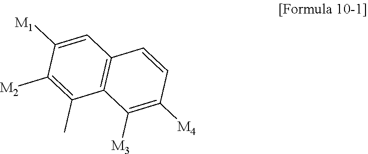

In [Formula 10-1], any one among M₁, M₂, M₃, and M₄ may be —OH, and the remainder may be —H.

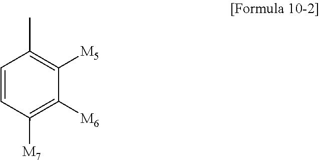

In [Formula 10-2], any one among M₅, M₆, and M₇ may be —OH, and the remainder may be —H.

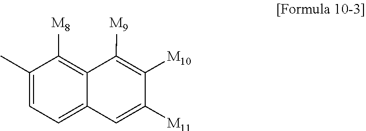

In [Formula 10-3], any one among M₈, M₉, M₁₀, and M₁₁ may be —OH, and the remainder may be —H.

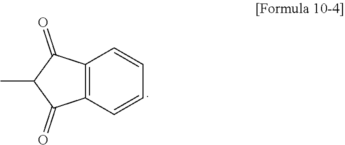

In an embodiment, the cyan dye may include a compound represented by [Formula 11].

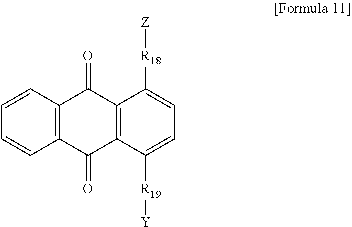

In [Formula 11], R₁₈ and R₁₉ may be each independently, O, S, Se, CH₂, NH or ester. In [Formula 11], Y and Z may be each independently —H, —CH₃, —C₂H₅, a linear alkyl group of 3 to 10 carbon atoms, a branched alkyl group of 3 to 10 carbon atoms, a linear alkene group of 3 to 10 carbon atoms, a branched alkene group of 3 to 10 carbon atoms, or one or more aromatic groups.

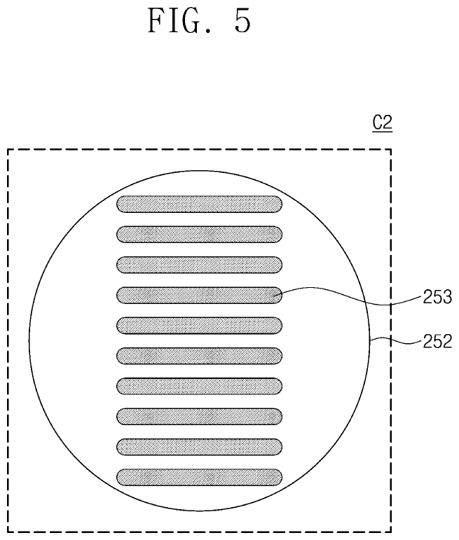

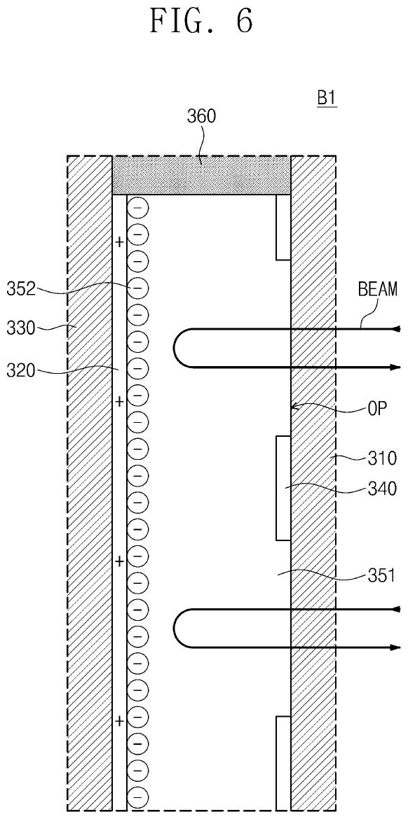

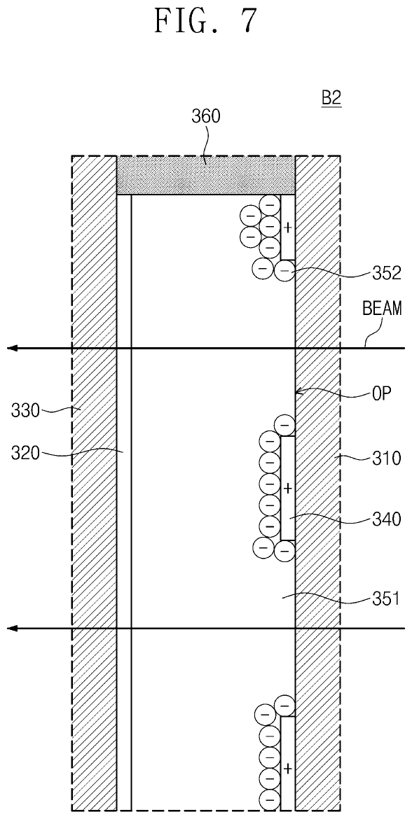

FIG. 5 is a concept diagram for explaining a portion of a transparent structure in a state of applying a driving voltage, and corresponds to an enlarged view on area C of FIG. 2. FIG. 6 is a concept diagram for explaining a portion of a transparent structure in a state of applying a driving voltage, and corresponds to an enlarged view on area B of FIG. 1. FIG. 7 is a concept diagram for explaining a portion of a transparent structure in a state of applying a driving voltage, and corresponds to an enlarged view on area B of FIG. 1.

Referring to FIG. 4 and FIG. 5, liquid crystals 253 in the liquid crystal droplets 252 may be scattered in a state of not applying a driving voltage. Accordingly, the first panel 200 may be a scattered mode C1. If a driving voltage is applied, an electric field may be formed between the first electrode 220 and the second electrode 240. The direction of the electric field may be a vertical direction to the first electrode 220 and the second electrode 240. In this case, the liquid crystals 253 may be aligned in parallel to the electric field. Accordingly, the first panel 200 may be a transparent mode C2.

Referring to FIG. 6, a driving voltage may be applied so that the third electrode 320 may exhibit (+) charge. In this case, charged particles 352 of which surfaces are charged with (−) charge may move toward the third electrode 320. The charged particles 352 may be uniformly aligned on the third electrode 320. Accordingly, the beam BEAM entered through openings OP in the fourth electrode 340 may be reflected by the charged particles 352 and goes out through the openings OP. Accordingly, the second panel 300 may become a reflection mode B1.

Referring to FIG. 7, a driving voltage may be applied so that the fourth electrode 340 may exhibit (+) charge. In this case, charged particles 352 of which surfaces are charged with (−) charge may move toward the fourth electrode 340 exhibiting (+) charge. The charged particles 352 may gather on the fourth electrode 340. The beam BEAM entered through the openings OP in the fourth electrode 340 may not collide with the charged particles 352 and penetrate the third electrode 320 and the third substrate 310. Accordingly, the second panel 300 may become a transmission mode B2.

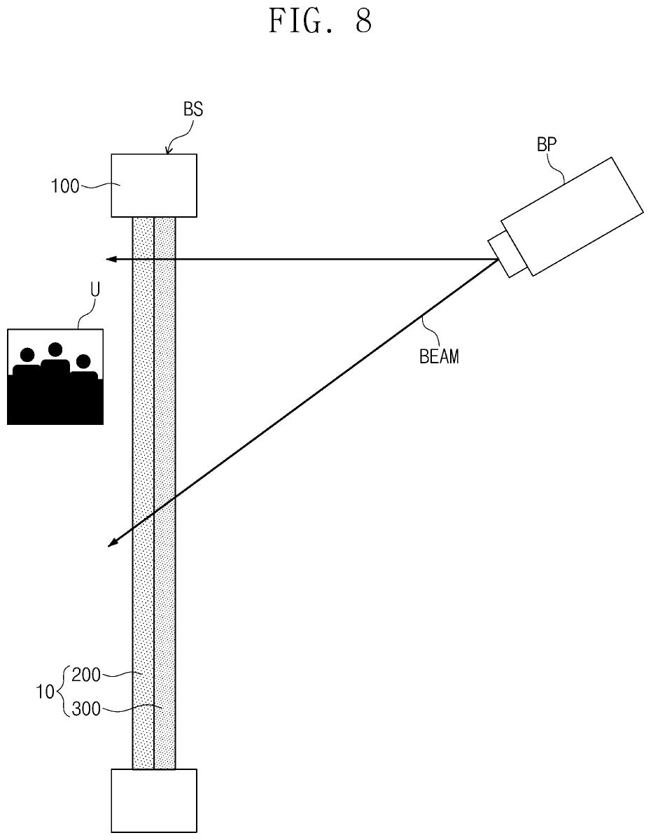

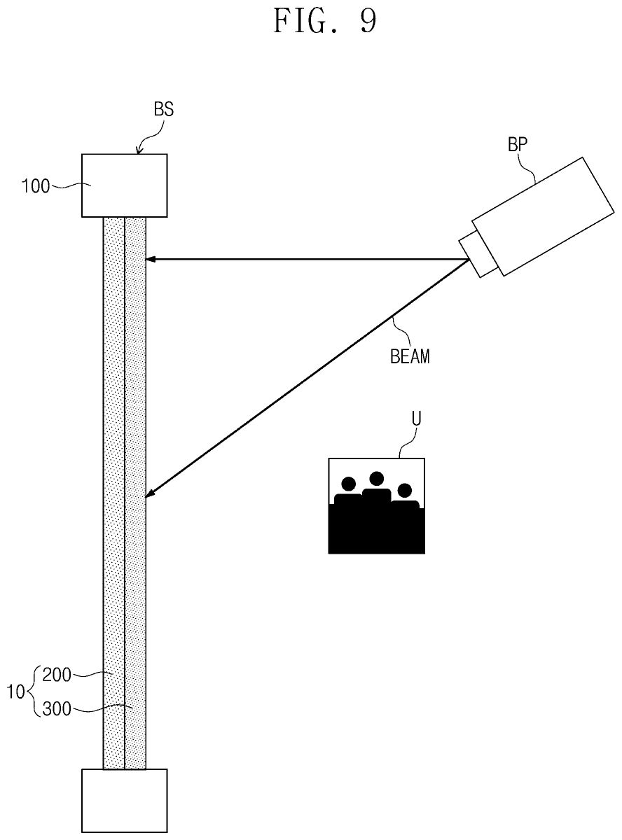

FIGS. 8 and 9 are concept diagrams showing screens for a beam projector including a transparent structure according to an embodiment of the inventive concept. Referring to FIG. 8 and FIG. 9, the screen BS for a beam projector may include a support 100 and a transparent structure 10.

If the screen BS for a beam projector is not used as a screen, the screen may be a transparent state. If a driving voltage is applied to the first panel 200 of the transparent structure 10, the first panel 200 may become a transparent mode C2, as explained referring to FIG. 5. By applying a driving voltage to the second panel 300, the first panel 200 of the transparent structure 10 may become a transmission mode B2, as explained referring to FIG. 7. Accordingly, the screen BS for a beam projector may be transparent.

Referring to FIG. 8, the screen BS for a beam projector may be a transmission type screen. A user U and a beam projector BP may be positioned at different sides with the screen BS for a beam projector therebetween. In this case, since a driving voltage is not applied to the first panel 200 of the transparent structure 10, the first panel 200 may be a scattering mode C1, as explained referring to FIG. 4. If a driving voltage is applied to the second panel 300 of the transparent structure 10, the second panel 300 may become a transmission mode B2, as explained referring to FIG. 7. Accordingly, the screen BS for a beam projector may be a transmission type screen.

Referring to FIG. 9, the screen BS for a beam projector may be a reflection type screen. A user U and a beam projector BP may be positioned at the same side with respect to the screen BS for a beam projector. In this case, a driving voltage is not applied to the first panel 200 of the transparent structure 10, and the first panel 200 may become a scattering mode C1, as explained referring to FIG. 4. If a driving voltage is applied to the second panel 300 of the transparent structure 10, the second panel 300 may become a reflection mode B1, as explained referring to FIG. 6. Accordingly, the screen BS for a beam projector may be a reflection type screen.

The transparent structure according to embodiments of the inventive concept may control the light transmission or not of a polymer dispersed liquid crystal layer in a first panel and a colloid layer in a second panel. Accordingly, a screen for a beam projector, including the transparent structure may be used as a transmission type screen or a reflection type screen. Since the change of an electric field according to the application of a driving voltage is utilized, quick change into a transmission type or a reflection type is possible. In addition, if a method of controlling an electrode by regions is applied, only a region used by a user may be transformed into a screen, or the transparent structure itself may sense a region where the beam projector projects, thereby serving selective transformation into a screen.

In addition, the screen for a beam projector, including the transparent structure according to embodiments of the inventive concept may be transformed into a transmission type or a reflection type screen dependent on the position of a user, without changing the position of the beam projector and the screen, and the screen for a beam projector with improved convenience may be provided.

The transparent structure according to an embodiment of the inventive concept may control the light transmission status of a polymer dispersed liquid crystal layer in a first panel and a colloid layer in a second panel, according to the application of a driving voltage. Accordingly, a screen for a beam projector, including the transparent structure may be used as a transmission-type screen or a reflection-type screen. Since the change of an electric filed according to the application of a driving voltage is utilized, the quick switch to the transmission type or the reflection type is possible.

The screen for a beam projector, including the transparent structure according to an embodiment of the inventive concept may be switched between a transmission-type and a reflection-type screen according to the position of a user without changing the positions of the beam projector and the screen. Accordingly, a screen for a beam projector, with improved convenience may be provided.

Although the embodiments of the present invention have been described, it is understood that the present invention should not be limited to these embodiments, but various changes and modifications can be made by one ordinary skilled in the art within the spirit and scope of the present invention as hereinafter claimed.

What is claimed is:

1. A transparent structure comprising a first panel and a second panel, wherein
the first panel comprises:
a first electrode;
a second electrode separated from the first electrode; and
a polymer dispersed liquid crystal layer disposed between the first electrode and the second electrode,
the second panel comprises:
a third electrode;
a fourth electrode separated from the third electrode; and
a colloid layer disposed between the third electrode and the fourth electrode,
the fourth electrode comprises multiple openings, and
the colloid layer comprises charged particles of which surfaces exhibit (+) charge or (−) charge.

2. The transparent structure of claim 1, wherein
the polymer dispersed liquid crystal layer comprises a ultraviolet curable polymer and first liquid crystals, and
the first liquid crystals have a weight ratio of 80 wt % to 120 wt % based on the ultraviolet curable polymer.

3. The transparent structure of claim 2, wherein the ultraviolet curable polymer is cured using ultraviolet with a wavelength of 250 nm to 400 nm, and energy with 50 mJ to 2000 mJ.

4. The transparent structure of claim 2, wherein
a flow viscosity of the first liquid crystals is from 15 mm²/s to 100 mm²/s,
a refractive index anisotropy of the first liquid crystals is from 0.10 to 0.30, and
a dielectric anisotropy of the first liquid crystals is from +2.0 to +50.0.

5. The transparent structure of claim 2, wherein
the polymer dispersed liquid crystal layer further comprises a black dye,
the black dye comprises at least one among a first black dye, a second black dye, and a third black dye,
the first black dye is a compound in which three naphthalene rings are connected via two azo groups,
the second black dye is a compound in which two naphthalene rings and one aromatic ring are connected via two azo groups, and
the third black dye is a compound in which three naphthalene rings and one aromatic ring are connected via three azo groups.

6. The transparent structure of claim 5, wherein the first black dye is represented by the following Formula 1, Formula 2 or Formula 3: 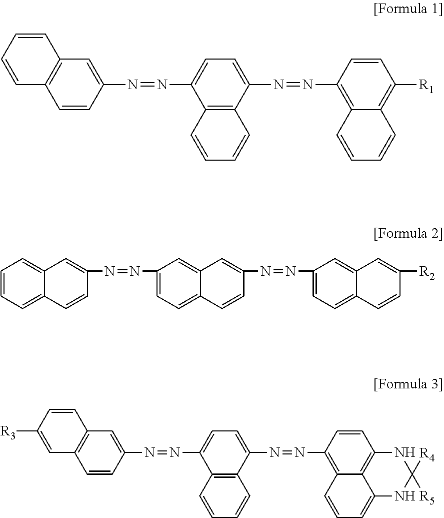
in Formula 1, Formula 2 and Formula 3, R₁, R₂, R₃, R₄, and R₅ are each independently —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

7. The transparent structure of claim 5, wherein the second black dye is represented by the following Formula 4, Formula 5 or Formula 6: 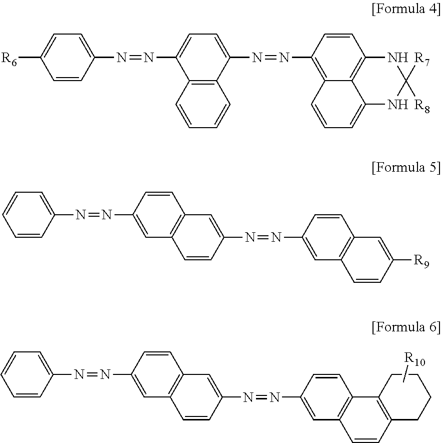
in Formula 4, Formula 5 and Formula 6, R₆, R₇, R₈, R₉, and R₁₀ are each independently —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

8. The transparent structure of claim 5, wherein the third black dye is represented by the following Formula 7 or Formula 8: 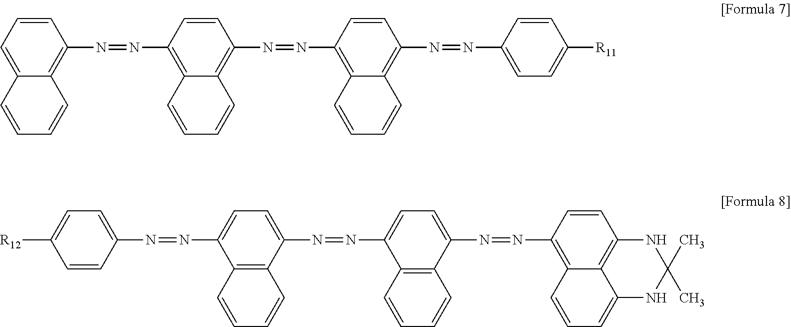
in Formula 7 and Formula 8, R₁₁ and R₁₂ are each independently —H, —CH₃, —C₂H₅, —C₃H₇, —C₄H₉, C₅H₁₁, a linear alkyl group of 6 to 8 carbon atoms, or a branched alkyl group of 3 to 8 carbon atoms.

9. The transparent structure of claim 1, wherein
the colloid layer further comprises a hydrophobic organic solvent, and
the hydrophobic organic solvent comprises at least one among halocarbon oil and Rhodiasolv IRIS oil.

10. The transparent structure of claim 1, wherein
the colloid layer further comprises second liquid crystals,
a flow viscosity of the second liquid crystals is from 20 mm²/s to 100 mm²/s,
a refractive index anisotropy of the second liquid crystals is from 0.05 to 0.30, and
a dielectric anisotropy of the second liquid crystals is from +5.0 to +40.0.

11. The transparent structure of claim 10, wherein
the colloid layer further comprises at least one among a yellow dye, a magenta dye, and a cyan dye, and
the yellow dye, the magenta dye, and the cyan dye have a weight ratio of 0.02 wt % to 10 wt % based on the second liquid crystals.

12. The transparent structure of claim 11, wherein the yellow dye is represented by the following Formula 9: 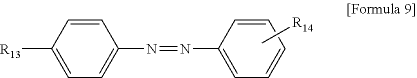
in Formula 9, R₁₃ is —N(CH₃)₂, —N(C₂H₅)₂ or —N(X)₂, where X is an alkyl chain of 3 to 10 carbon atoms,
in Formula 9, R₁₄ is —H, —CH₃, —C₂H₅, a linear alkyl group of 3 to 10 carbon atoms, a branched alkyl group of 3 to 10 carbon atoms, a linear alkene group of 3 to 10 carbon atoms, a branched alkene group of 3 to 10 carbon atoms, or one or more aromatic groups.

13. The transparent structure of claim 11, wherein the magenta dye is represented by the following Formula 10: 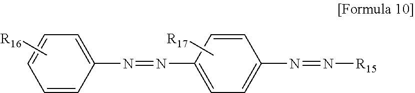
in Formula 10, R₁₆ and R₁₇ are each independently, —H, —CH₃, —C₂H₅, a linear alkyl group of 3 to 10 carbon atoms, a branched alkyl group of 3 to 10 carbon atoms, a linear alkene group of 3 to 10 carbon atoms, a branched alkene group of 3 to 10 carbon atoms, or one or more aromatic groups,
in Formula 10, R₁₅ is represented by the following Formula 10-1, Formula 10-2, Formula 10-3, or Formula 10-4: 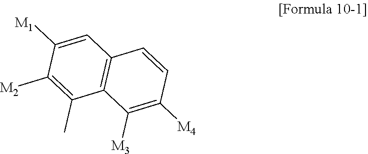
in Formula 10-1, any one among M₁, M₂, M₃, and M₄ is —OH, and the remainder are —H: 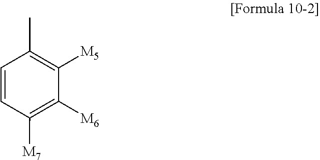
in Formula 10-2, any one among M₅, M₆, and M₇ is —OH, and the remainder are —H: 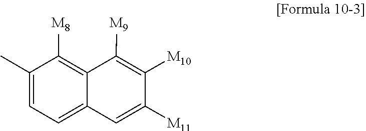
in Formula 10-3, any one among M₈, M₉, M₁₀, and M₁₁ is —OH, and the remainder are —H:

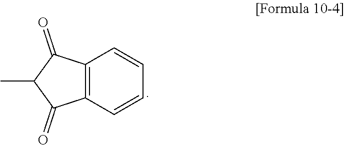

14. The transparent structure of claim 11, wherein the cyan dye is represented by the following Formula 11: 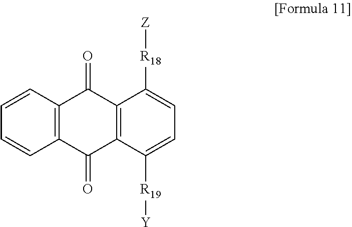
in Formula 11, R₁₈ and R₁₉ are each independently, O, S, Se, CH₂, NH or ester,
in Formula 11, Y and Z are each independently —H, —CH₃, —C₂H₅, a linear alkyl group of 3 to 10 carbon atoms, a branched alkyl group of 3 to 10 carbon atoms, a linear alkene group of 3 to 10 carbon atoms, a branched alkene group of 3 to 10 carbon atoms, or one or more aromatic groups.

15. The transparent structure of claim 1, wherein
the first panel comprises a first control part connected with the first electrode and the second electrode, and
the second panel comprises a second control part connected with the third electrode and the fourth electrode.

16. A transparent structure comprising:
a first panel; and
a second panel on the first panel, wherein
the first panel comprises:
a first transparent substrate;
a first transparent electrode on the first transparent substrate;
a second transparent electrode separated from the first transparent electrode;
a second transparent substrate on the second transparent electrode;
a polymer dispersed liquid crystal layer disposed between the first transparent electrode and the second transparent electrode; and
a first control part connected with the first transparent electrode and the second transparent electrode,
the second panel comprises:
a third transparent substrate;
a third transparent electrode on the third transparent substrate;
a fourth transparent electrode separated from the third transparent electrode and comprising multiple openings;
a fourth transparent substrate on the fourth transparent electrode;
a colloid layer disposed between the third transparent electrode and the fourth transparent electrode; and
a second control part connected with the third transparent electrode and the fourth transparent electrode,
the polymer dispersed liquid crystal layer comprises a ultraviolet curable polymer and first liquid crystals, and
the colloid layer comprises charged particles of which surfaces exhibit (+) charge or (−) charge.

17. The transparent structure of claim 16, wherein, if a voltage is applied through the first control part to the first transparent electrode and the second transparent electrode, the first liquid crystals are aligned in parallel to each other.

18. The transparent structure of claim 16, wherein, if a voltage is applied through the second control part to the third transparent electrode and the fourth transparent electrode, the charged particles move to the third transparent electrode or the fourth transparent electrode.
